(19) United States
(12) Patent Application Publication
(10) Pub. No.: US 2004/0179383 A1
(43) Pub. Date: Sep. 16, 2004

(54) Micro power converter with multiple outputs

(76) Inventors: Masaharu Edo, Kanagawa (JP); Haruhiko Nishio, Nagano (JP)

Correspondence Address: HAUPTMAN KANESAKA BERNER PATENT AGENTS, LLP, 1700 Diagonal Road, Suite 310, Alexandria, VA, 22314, US

(21) Appl. No.: 10/782,755

(22) Filed: Feb. 23, 2004

(30) Foreign Application Priority Data
Mar. 14, 2003 (JP) 2003-069954
May 26, 2003 (JP) 2003-147107

(51) Int. Cl. H02P 1/46

(52) U.S. Cl. 363/111

(57) ABSTRACT

A micro power converter with multiple outputs includes a semiconductor substrate with a semiconductor integrated circuit formed thereon, a thin film magnetic induction unit, and a capacitor. The thin film magnetic induction unit is formed of a plurality of thin film magnetic induction components formed on magnetic insulation substrates, and a magnetic isolation layer is provided for magnetically isolating the thin film magnetic induction components with each other.

### BACKGROUND OF THE INVENTION AND RELATED ART STATEMENT

The present invention relates to a micro power converter with multiple outputs, such as a DC-DC converter comprising a semiconductor integrated circuit (hereinafter referred to as IC) formed on a semiconductor substrate and a passive component such as a coil, a capacitor, a resistor and the like.

Recently, electronic information apparatuses, particularly a variety of portable electronic information apparatuses, have been widely used. Many of the electronic information apparatuses have a battery as a power source and are equipped with a power converter such as a DC-DC converter. A power converter generally has a hybrid type module structure comprising active and passive discrete components arranged on a printed circuit board made of ceramic or plastic. The active components include switching devices, rectifying devices and controller ICs, and the passive components include coils, transformers, capacitors and resistors. FIG. 32 shows a circuit diagram of a DC-DC converter. The DC-DC converter circuit is represented as a portion inside dotted line 50.

The DC-DC converter comprises an input capacitor Ci, an output capacitor Co, a regulator resistor RT, a capacitor CT., an inductor L, and a power supply IC. A DC voltage Vi is input so that a MOSFET of the power supply IC is switched on and off to output a specified DC output voltage Vo. The inductor L and the output capacitor Co constitute a filter circuit for outputting the DC voltage.

When a DC resistance of the inductor L in the circuit increases, a voltage drop at the component increases, resulting in a decrease of the output voltage Vo, i.e. a decrease of conversion efficiency of the DC-DC converter. With a demand for reducing a size of a variety of electronic information apparatuses including the portable device described above, it has been required to reduce a size of a power converter installed in the apparatus. A size of the hybrid type power supply module has been reduced through MCM (multiple-chip module) technique and advance in a laminated ceramic component. However, since it is necessary to arrange discrete components on a substrate, reduction of a mounting area of the power supply module has been limited. In particular, magnetic induction components such as inductors and transformers are larger than ICs, thereby imposing most severe restraint for reducing a size of the electronic apparatus.

There have been two approaches for reducing a size of the magnetic induction component; i.e. one in which a size of the magnetic induction component is reduced to a limit as a chip part, and a total size of a power supply is reduced through planar mounting of the chip part, and the other in which the magnetic induction component is formed on a silicon substrate as a thin film. Recently, to meet the demand for minimizing the magnetic induction component, Japanese Patent Publication (KOKAI) No. 2001-196542 has disclosed an example in which a thin micro magnetic component (coil and transformer) is mounted on a semiconductor substrate through an application of semiconductor technology.

In the example, semiconductor components such as switching elements and controller circuits are incorporated into a semiconductor substrate, and a planar magnetic induction component (thin film inductor) formed of a thin film coil sandwiched by a magnetic thin film and a ferrite substrate is formed on a surface of the semiconductor substrate through thin film technology. With this approach, it is possible to reduce a thickness of the magnetic induction component and a mounting area thereof. However, it is still necessary to mount a large number of chip parts, and a mounting area is still large.

To solve the problem, Japanese Patent Publication (KOKAI) No. 2002-233140 has disclosed a micro power converter. A planar magnetic induction component in the micro power converter has a spiral-shaped coil conductor with a gap filled with a resin containing magnetic fine particles and sandwiched by ferrite substrates on upper and lower surfaces thereof.

The micro power converter described above has a small size and thickness, however, has only a single magnetic inductor component and a single IC for a single output system, i.e. one input and one output. When multiple outputs are necessary, it is necessary to provide a plurality of micro power converters. Many of portable electronic apparatuses require a micro power converter with multiple outputs, i.e. multiple output voltages. Therefore, it is necessary to mount a plurality of micro power converters, thereby increasing a mounting area of the micro power converters and mounting cost.

In view of the problems described above, an object of the present invention is to provide a micro power converter with multiple outputs for supplying multiple output voltages and having a small size, thickness and mounting area.

Further objects and advantages of the invention will be apparent from the following description of the invention.

### SUMMARY OF THE INVENTION

To attain the objects described above, according to a first aspect of the present invention, a micro power converter with multiple outputs includes a semiconductor substrate with a semiconductor integrated circuit formed thereon, a thin film magnetic induction unit, and a capacitor. The thin film magnetic induction unit is formed of a plurality of thin film magnetic induction components formed on magnetic insulation substrates, and a magnetic isolation layer is provided for magnetically isolating the thin film magnetic induction components with each other.

According to a second aspect of the present invention, a micro power converter with multiple outputs includes a semiconductor substrate with a semiconductor integrated circuit formed thereon, a thin film magnetic induction unit, and a capacitor. The thin film magnetic induction unit is formed a plurality of thin film magnetic induction components. Each of the thin film magnetic induction components includes a magnetic insulation substrate, a coil conductor formed on the magnetic insulation substrate, and a plurality of connection terminals formed at a peripheral portion of the magnetic insulation substrate. The thin film magnetic induction components are laminated, and are fixed with the connection terminals with a gap therebetween.

In the micro power converter with multiple outputs according to the first or second aspect of the invention, the magnetic insulation substrate may be a ferrite substrate. In the micro power converter with multiple outputs according to the first aspect of the invention, the thin film magnetic induction components may be magnetically isolated with each other with a non-magnetic material. The non-magnetic material may be a resin material or a ceramic material.

Further, in the micro power converter with multiple outputs according to the second aspect of the invention, the connection terminals may be formed at same planar positions on each of the magnetic insulation substrates. In the thin film magnetic induction components, the connection terminals connected to both ends of the coil conductor may be positioned at planar positions different with each other. Also, in at least one of two adjacent magnetic insulation substrates, the connection terminals may have a height higher than the coil conductor formed on the at least one magnetic insulation substrate.

In the micro power converter with multiple outputs according to the first or second aspects of the invention, the magnetic insulation substrate may have a first principal surface and a second principal surface. The connection terminals may be formed on the first principal surface and the second principal surface, and may be electrically connected through a through hole formed in the magnetic insulation substrate. Further, the connection terminals may be electrically connected to the semiconductor substrate. Also, the connection terminals may be electrically connected to the capacitor.

### BRIEF DESCRIPTION OF THE DRAWINGS

FIG. 1 is a plan view of an essential part of an inductor in a micro power converter with multiple outputs according to a first embodiment of the present invention;

FIGS. 2(a) and 2(b) are explanatory sectional views showing the essential part of the inductor, wherein FIG. 2(a) is an explanatory cross sectional view taken along line 2(a)-2(a) in FIG. 1, and FIG. 2(b) is an explanatory cross sectional view taken along line 2(b)-2(b) in FIG. 1;

FIG. 3 is an explanatory cross sectional view of an essential part of the micro power converter with multiple outputs according to the first embodiment of the present invention;

FIG. 4 is a view showing a step of manufacturing the micro power converter with multiple outputs according to the first embodiment of the present invention;

FIG. 5 is a view showing a step of manufacturing the micro power converter with multiple outputs according to the first embodiment of the present invention continued from FIG. 4;

FIG. 6 is a view showing a step of manufacturing the micro power converter with multiple outputs according to the first embodiment of the present invention continued from FIG. 5;

FIG. 7 is a view showing a step of manufacturing the micro power converter with multiple outputs according to the first embodiment of the present invention continued from FIG. 6;

FIG. 8 is a view showing a step of manufacturing the micro power converter with multiple outputs according to the first embodiment of the present invention continued from FIG. 7;

FIG. 9 is a view showing a step of manufacturing the micro power converter with multiple outputs according to the first embodiment of the present invention continued from FIG. 8;

FIG. 10 is a view showing a step of manufacturing the micro power converter with multiple outputs according to the first embodiment of the present invention continued from FIG. 9;

FIG. 11 is a view showing a step of manufacturing the micro power converter with multiple outputs according to the first embodiment of the present invention continued from FIG. 10;

FIG. 12 is a view showing a step of manufacturing the micro power converter with multiple outputs according to the first embodiment of the present invention continued from FIG. 11;

FIG. 13 is a view showing a step of manufacturing the micro power converter with multiple outputs according to the first embodiment of the present invention continued from FIG. 12;

FIGS. 14(a) to 14(c) are views showing steps of forming a ferrite substrate of a micro power converter with multiple outputs according to a second embodiment of the present invention;

FIG. 15 is a view showing a magnetic insulation substrate with four inductors mounted thereon;

FIGS. 16(a) and 16(b) are views showing a configuration of a micro power converter with multiple outputs according to a third embodiment of the present invention, wherein FIG. 16(a) is a plan view of a first inductor, and FIG. 16(b) is a plan view of a second inductor;

FIGS. 17(a) and 17(b) are explanatory sectional views showing a laminated structure of the first inductor and second inductor shown in FIGS. 16(a) and 16(b), wherein FIG. 17(a) is an explanatory cross sectional view taken along lines 17(a)-17(a) in FIGS. 16(a) and 16(b), and FIG. 17(b) is an explanatory cross sectional view taken along line 17(b)-17(b) in FIGS. 16(a) and 16(b);

FIG. 18 is an explanatory cross sectional view of an essential part of a micro power converter with multiple outputs according to a fourth embodiment of the present invention;

FIG. 19 is a view showing a step of manufacturing the micro power converter with multiple outputs shown in FIG. 18;

FIG. 20 is a view showing a step of manufacturing the micro power converter with multiple outputs shown in FIG. 18 continued from FIG. 19;

FIG. 21 is a view showing a step of manufacturing the micro power converter with multiple outputs shown in FIG. 18 continued from FIG. 20;

FIG. 22 is a view showing a step of manufacturing the micro power converter with multiple outputs shown in FIG. 18 continued from FIG. 21;

FIG. 23 is a view showing a step of manufacturing the micro power converter with multiple outputs shown in FIG. 18 continued from FIG. 22;

FIG. 24 is a view showing a step of manufacturing the micro power converter with multiple outputs shown in FIG. 18 continued from FIG. 23;

FIG. 25 is a view showing a step of manufacturing the micro power converter with multiple outputs shown in FIG. 18 continued from FIG. 24;

FIG. 26 is a view showing a step of manufacturing the micro power converter with multiple outputs shown in FIG. 18 continued from FIG. 25;

FIG. 27 is a view showing a step of manufacturing the micro power converter with multiple outputs shown in FIG. 18 continued from FIG. 26;

FIG. 28 is a view showing a step of manufacturing the micro power converter with multiple outputs shown in FIG. 18 continued from FIG. 27;

FIG. 29 is a view showing a step of manufacturing the micro power converter with multiple outputs shown in FIG. 18 continued from FIG. 28;

FIG. 30 is a view showing a coil with a toroidal shape;

FIG. 31 is a view showing a coil with a spiral shape; and

FIG. 32 is a view showing a DC-DC converter circuit.

### DETAILED DESCRIPTION OF PREFERRED EMBODIMENTS

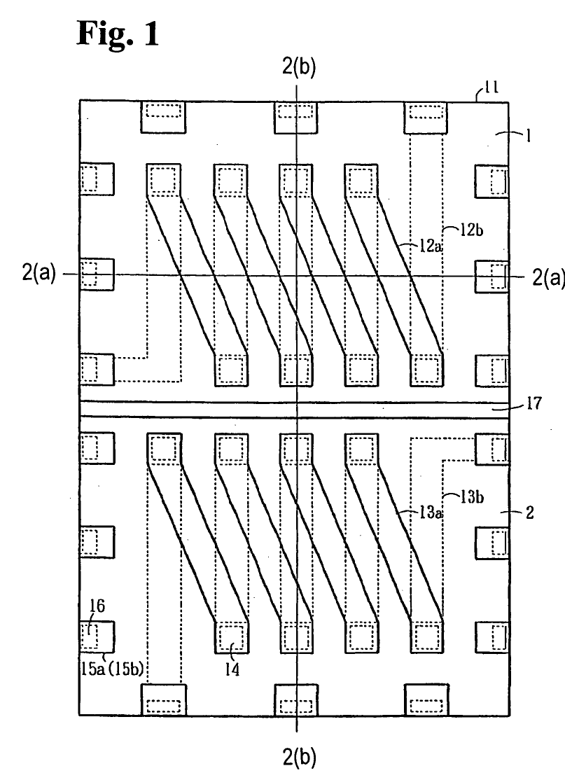

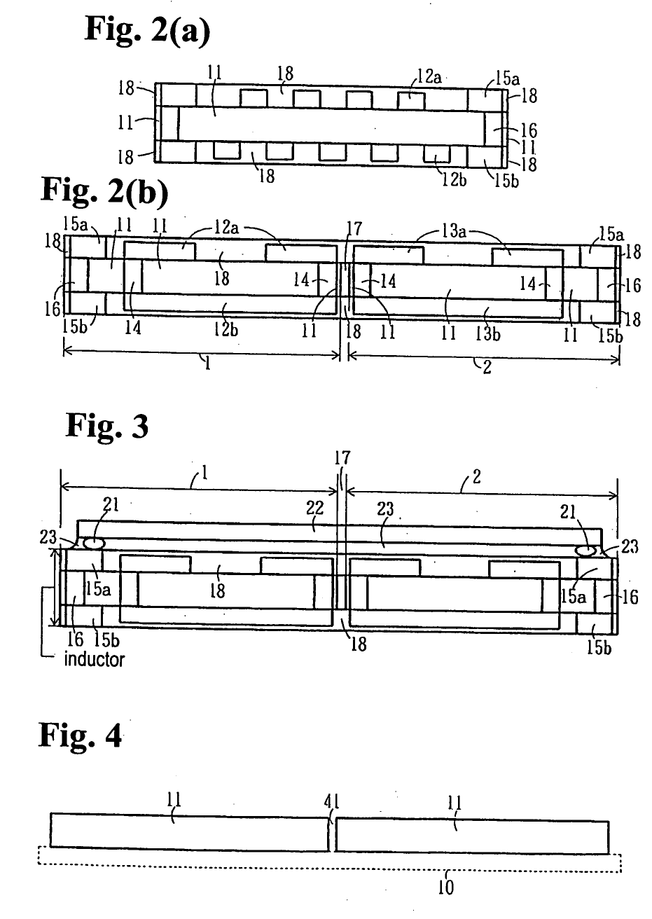

Hereunder, embodiments of the present invention will be explained with reference to the accompanying drawings. FIG. 1 and FIGS. 2(a) and 2(b) are views showing an essential structure of a micro power converter with multiple outputs according to a first embodiment of the present invention. FIG. 1 is a top plan view of an inductor, i.e. a thin film magnetic induction component. FIG. 2(a) is a cross sectional view taken along line 2(a)-2(a) in FIG. 1, and FIG. 2(b) is a cross sectional view taken along line 2(b)-2(b) in FIG. 1. There are two inductors in the embodiment. FIGS. 1, 2(a) and 2(b) show a coil pattern of the inductors as well as connection terminals 15a and 15b as mounted terminals for electrically connecting the inductors.

In FIG. 1, coil conductors 12a and 13a are formed on first principal surfaces of magnetic insulation substrate 11, and coil conductors 12b and 13b are formed on second principal surfaces of the substrates. The coil conductors 12b and 13b formed on the second principal surfaces have a straight linear shape in a plan view. The coil conductors 12b and 13b are electrically connected to the coil conductors 12a and 13a on the first principal surfaces through connecting conductors 14 formed at through holes. The coil conductors 12a and 13a on the first principal surfaces are formed slightly oblique with respect to the coil conductors 12b and 13b. The coil conductor 12a, the coil conductor 12b, and the connecting conductor 14 form a solenoid coil, and the coil conductor 13a, the coil conductor 13b, and the connecting conductor 14 form a solenoid coil, respectively.

A magnetic isolation layer 17 formed of a non-magnetic material is disposed between the magnetic insulation substrates 11. The magnetic isolation layer 17 magnetically isolates an inductor 1 (thin film magnetic inductive component) comprising the magnetic insulation substrate 11, the coil conductors 12a and 12b, and the connecting conductor 14 from an inductor 2 (thin film magnetic inductive component) comprising the magnetic insulation substrate 11, the coil conductors 13a and 13b, and the connecting conductor 14. That is, when a voltage is applied to each of the inductor 1 and inductor 2 upon an operation as a power supply, mutual inductance is not generated (too small to affect the operation as a power supply).

FIG. 3 is a cross sectional view of a principal part of the micro power converter with multiple outputs of the first embodiment. A semiconductor substrate 22 with a power supply integrated circuit (IC) formed thereon is disposed on a surface (upper surface) of the magnetic insulation substrates 11, so that the inductors and the power supply IC, i.e. two major components of a power converter, are integrated to have a compact size. The power supply IC is designed to have two output systems, and two inductors are provided for two power conversion output systems. Stud bumps 21 are formed on electrodes of the power supply IC on the semiconductor substrate 22. The semiconductor substrate 22 and the connection terminals 15a formed on the magnetic insulation substrates 11 are ultrasonically bonded through the stud bumps 21, and are sealed with an under-filling 23 if necessary.

A capacitor is omitted in FIG. 3. A capacitor may be provided externally. When a capacitor component such as a laminated ceramic capacitor array is connected to the connection terminals 15b formed on the other side of the magnetic insulation substrate 11, it is possible to further reduce a size of the device. The connection terminals 15a and 15b are electrically connected through connecting conductors 16. The coil conductors 12a, 12b, 13a, and 13b are covered with a protective film 18 formed of an insulation resin material (not shown in FIG. 1).

FIGS. 4 through 13 are cross sectional views showing essential steps of manufacturing the micro power converter with multiple outputs of the first embodiment. A method of manufacturing the inductors is shown here, and the cross sectional views are similar to the cross sectional view taken along line 2(b)-2(b) in FIG. 1.

A ferrite substrate 11 formed of Ni—Zn and having a thickness of 525 μm is used as the magnetic insulation substrate. A thickness of the magnetic insulation substrate is determined according to required inductance, a value of coil current, and properties of the magnetic substrate, and is not limited to the embodiment. When the magnetic insulation substrate has an extremely small thickness, magnetic saturation tends to occur, and when the substrate has a large thickness, the power converter itself has a large thickness. Accordingly, it is necessary to select a thickness according to a purpose of the power converter. The ferrite is used for the magnetic insulation substrate. Alternatively, other materials with appropriate insulation and magnetic properties may be used. The ferrite substrate is selected, as it is easy to form in a substrate shape.

First, as shown in FIG. 4, the ferrite substrate 11 is cut so that the magnetic isolation layer is formed in the ferrite substrate. The cutting can be conducted using a method such as laser beam machining, sand blasting, electric discharge machining, ultrasonic machining, and dicing. In the embodiment, the magnetic insulation substrate is cut into two halves with dicing. The magnetic insulation substrate is fixed on a tape 10 in advance so that the magnetic insulation substrates are not separated after the cutting. A blade of the dicing has a thickness of 60 μm, and a gap 41 after the cutting is 70 μm.

The tape 10 may be a thermal peeling tape in which adhesion thereof decreases when heated or an ultraviolet radiation peeling tape in which adhesion thereof decreases when ultraviolet light is irradiated. Any tape can be used as far as the tape maintains adhesion during the dicing and is easily peeled off in a later step. An ultraviolet radiation peeling tape is used in the embodiment.

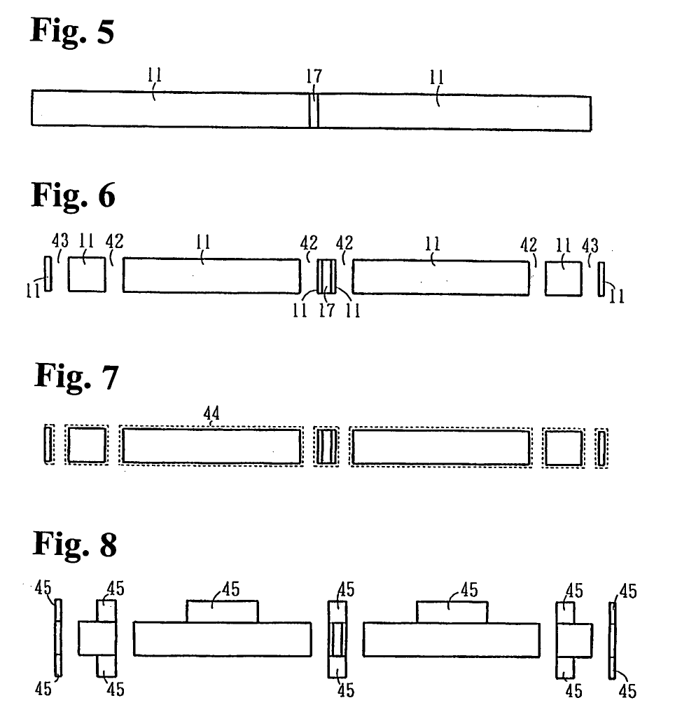

As shown in FIG. 5, a liquid resin is filled in the cut gap and is cured to form the magnetic isolation layer 17 formed of a non-magnetic material, so that the two magnetic insulation substrates are bonded with the magnetic isolation layer 17. The liquid resin is applied to the cut gap with screen print method, and is cured. This step is repeated several times to fill the cut gap, and a surface of the resin is polished to eliminate a step between a surface of the ferrite substrate and the resin surface.

As shown in FIG. 6, through holes 42 and 43 are formed for connecting the coil conductors 12a, 12b, 13a, and 13b, and connection terminals 15a and 15b to be formed on the first and second principal surfaces. The coil conductors are connected through the through holes 42, and the connection terminals are connected through the through holes 43. The through holes 42 and 43 can be formed with a method such as laser beam machining, sand blasting, electric discharge machining, ultrasonic machining, and drilling to be selected according to machining cost and machining dimension. In the embodiment, the sand blasting method is employed, since a minimum width of machining dimension is 130 μm and a large number of places are machined.

As shown in FIG. 7, Ti/Cu is deposited on the whole surfaces of the magnetic insulation substrates with sputtering to form plating seed layers 44 before the connecting conductors 14 and 16 are formed in the through holes 42 and 43, and the coil conductors 12a, 12b, 13a and 13b, and the connection terminals 15a and 15b are formed on the first and second principal surfaces. The plating seed layers 44 can alternatively formed with electroless plating. Instead of the sputtering method, vacuum deposition or CVD (chemical vapor deposition) may be used. It is preferred that the deposited layer has a sufficient adhesion to the ferrite substrate 1. The conductive material may be any appropriate material with electrical conductivity. In the embodiment, titanium is used as an adhesive layer to obtain good adhesion, and other materials such as Cr, W, Nb, and Ta may be used. The copper layer is a seed layer to be plated in the nest step of electroplating, and nickel or gold may be used instead of copper. In the embodiment, Ti/Cu is used considering ease of machining in the later steps.

Then, as shown in FIG. 8, a pattern is formed using photo-resist 45 for the coil conductors 12a, 12b, 13a and 13b and connection terminals 15a and 15b to be formed on the first and second principal surfaces. A negative film type photo-resist 45 is used to form the pattern.

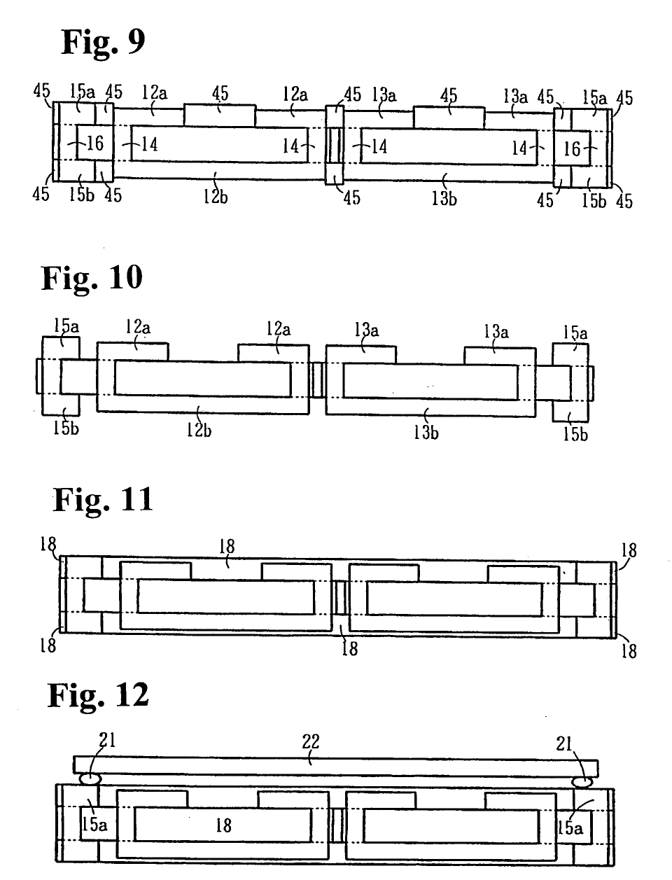

As shown in FIG. 9, copper is plated at opening portions of the resist pattern to form the coil conductors 12a, 12b, 13a and 13b formed of copper in a pattern. The through holes 42 and 43 are plated with copper to form the connecting conductors 14 and 16 formed of copper in a pattern. The coil conductors 12a and 13a on the first principal surface and the coil conductors 12b and 13b on the second principal surface are connected by the connecting conductors, so that a coil pattern having a solenoid shape is formed. At this stage, the plating seed layer 44 remains on the whole surface of the ferrite substrate 11.

After the electroplating, as shown in FIG. 10, the photo-resist 45 and unnecessary conductive layer (seed layer 44 formed of Ti/Cu) are removed. Accordingly, the coil conductors with a solenoid shape comprising the coil conductors 12a, 12b, 13a and 13b and the connection terminals 15a and 15b are obtained. Then, as shown in FIG. 11, an insulator film is formed on the coil conductors 12a, 12b, 13a and 13b to form a protective layer 18. In the embodiment, the film type insulator material is used. The protective film is not indispensable. However, it is preferred that the film is formed considering long-term reliability. The protective film is not limited to the film type, and a liquid insulator material may be applied by screen print in a pattern and thermally cured.

Incidentally, if necessary, nickel or gold may be plated on the surfaces of the coil conductors 12a, 12b, 13a and 13b and the connection terminals 15a and 15b to form a surface treatment layer. In the embodiment, in the step shown in FIG. 9, nickel and gold (not shown) are plated after copper is plated. The surface treatment layer may be formed with electroless plating after the step shown in FIG. 10 or the step shown FIG. 11. The protective metallic conductive layer is provided for obtaining stable connection when the IC is connected in a later step.

As shown in FIG. 12, the semiconductor substrate 22 with the power supply IC mounted thereon is connected to the connection terminals 15a formed on the ferrite substrates 11. In the embodiment, stud bumps 21 are formed on an electrode (not shown) of the semiconductor substrate, and the stud bumps are fixed to the connection terminals 15a with ultrasonic bonding.

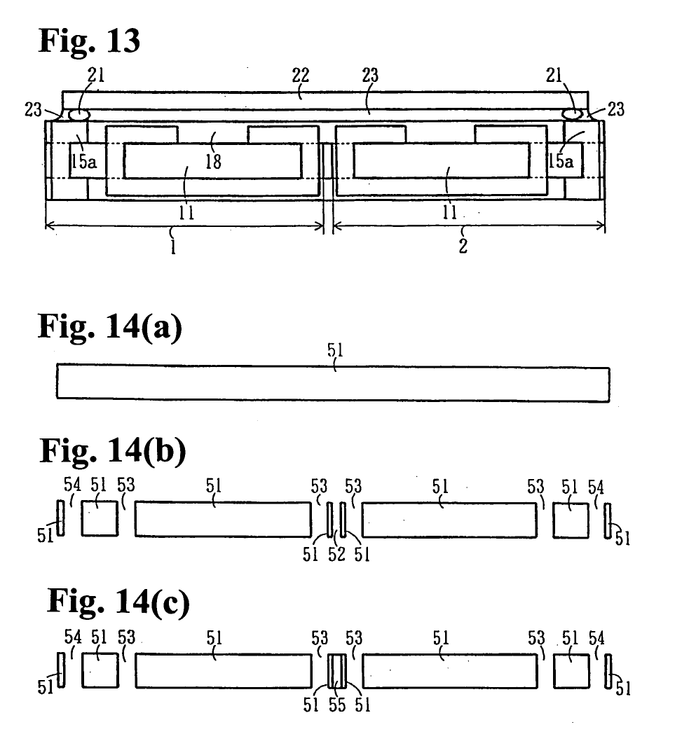

As shown in FIG. 13, the semiconductor substrate 22 is fastened to the inductors 1 and 2 with the under-filling 23. In the embodiment, the semiconductor substrate 22 is fixed to the inductors 1 and 2 with the stud bumps 21 and ultrasonic bonding. A method of the fixing is not limited thereto, and soldering or a conductive adhesive may be used. It is preferred that a connection point has a resistance as small as possible.

In the embodiment, the semiconductor substrate 22 is fastened to the inductors 1 and 2 with the under-filling. A material such as an epoxy resin may be used for the under-filling. The under-filling fastens each of the components (IC and inductors) for eliminating an effect of moisture for long-term reliability, and has no effect on initial performance of the power converter. It is preferred to provide the under-filling for the long-term reliability.

With the process described above, it is possible to reduce a size of the power converter with the parts (power supply IC and inductors) mounted thereon other than the capacitor. The power converter has two output systems and a mounting area smaller than a case in which two micro power converters with a single output system are arranged.

In particular, a micro power converter with a single output system has a size of 3.5 mm wide and 3.5 mm long. Accordingly, it is necessary to provide a mounting area of at least 3.5 mm×7.2 mm to obtain two output systems. In the micro power converter with multiple outputs having two output systems, the mounting area needs to be 3.5 mm wide and 5.8 mm long, since the power supply IC has a smaller number of electrodes, or the electrodes can be shared by the two output systems. A thickness is about 1 mm equal to a thickness of a micro power supply with a single output system. Accordingly, it is possible to reduce the mounting area and the assembling steps in which two micro power converters is converted to one micro power converter with multiple outputs, thereby reducing mounting cost by half.

A ceramic capacitor and the like may be bonded to the connection terminals of the inductor on a surface opposite to the surface that the IC is mounted, thereby further reducing a size.

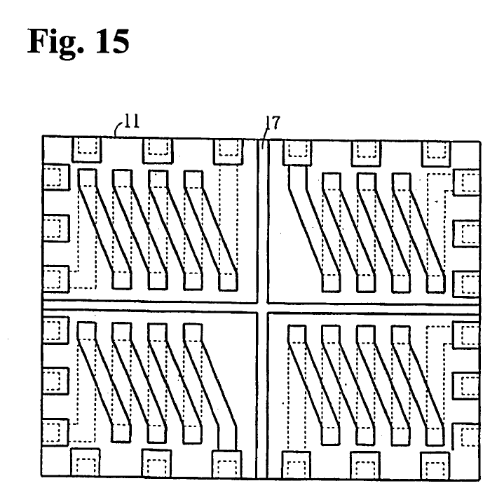

FIGS. 14(a) to 14(c) are views showing a method of manufacturing a micro power converter with multiple outputs according to a second embodiment of the present invention. FIGS. 14(a) through 14(c) are cross sectional views showing sequential steps of manufacturing a ferrite substrate.

In the second embodiment, a ceramic material is used for the magnetic isolation layer 17 in place of the resin in the first embodiment. In the first embodiment, the resin is filled in the cut gap 41 of the ferrite substrates 11 after sintering the ferrite. In the second embodiment, the ferrite and the ceramic are simultaneously sintered.

First, as shown in FIG. 14(a), a green sheet 51 is prepared before sintering the ferrite. A cut gap 52 and through holes 53 and 54 are formed in the green sheet 51 with punching as shown in FIG. 14(b). As shown in FIG. 14(c), the gap 52 is filled with ceramic paste 55 of alumina with printing method before sintering. In this state, the ferrite and the ceramics are sintered at 1,200° C. At this time, a sintering temperature, a shrinkage due to the sintering, and coefficient of thermal expansion of the ferrite and the ceramics are adjusted so that a crack is prevented after the sintering and positional accuracy of the through holes is adjusted.

In the embodiment, alumina is used for the ceramic material, and any material such as barium titanate, magnesium oxide, zinc oxide, and PZT (lead zirconate titanate) can be used as far as coefficient of thermal expansion and thermal shrinkage are adjustable relative to the ferrite.

After the ferrite substrate is formed, steps for forming the coils are similar to the steps shown in FIGS. 7 through 13. As compared with the first embodiment, the power converter of the second embodiment exhibits superior heat resistance, and better long-term reliability including pressure cooker tests and THB (high temperature, high humidity, and voltage application test). Further, since the coefficients of thermal expansion of the materials are adjusted, the power converter of the second embodiment exhibits better performance in such reliability tests as heat cycle test and heat shock test, as well as the advantages of the first embodiment.

In the second embodiment, two inductors are formed, and the number of the inductors can be increased according to the output systems. FIG. 15 shows an example in which four inductors are integrated. It is possible to design the configuration according to the output systems of a portable device, mounting cost and cost of the power converter.

In the second embodiment, the inductors have the solenoid pattern, and a spiral shape or a toroidal shape may be applicable to the micro power converter with multiple outputs.

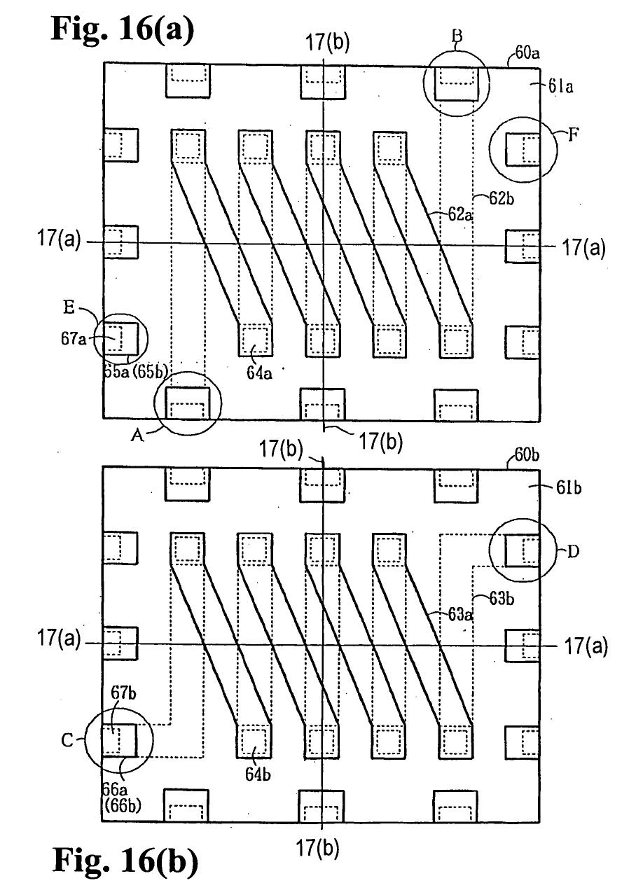

FIGS. 16(a) and 16(b) are views showing an essential part of a micro power converter with multiple outputs according to a third embodiment of the present invention. FIG. 16(a) is a plan view of a first inductor and FIG. 16(b) is a plan view of a second inductor. Each of the drawings is a top plan view of an inductor or a thin film magnetic induction component.

A first inductor 60a comprises a first magnetic insulation substrate 61a (hereinafter referred to as first substrate 61a) with first coil conductors 62a and 62b and first connection terminals 65a and 65b mounted thereon. A second inductor 60b comprises a second magnetic insulation substrate 61b (hereinafter referred to as second substrate 61b) with second coil inductors 63a and 63b and second connection terminals 66a and 66b mounted thereon. The coil conductors 62a and 63a and the connection terminals 65a and 66a are formed on first principal surfaces, and the coil conductors 62b and 63b and the connection terminals 65b and 66b are formed on second principal surfaces.

The first connection terminals 65a connected to the first coil conductors 62a are disposed at planar positions shifted from those of the second connection terminals 66a connected to the second coil conductors 63a, so that the two inductors can be operated independently for obtaining two outputs. The first connection terminals connected to the first coil conductors 62b may be disposed at planar positions same as those of the second connection terminals 66a connected to the second coil conductors 63b. FIGS. 16(a) and 16(b) show a case that the planar positions are shifted. The first connection terminals 65b and the second connection terminals 66a disposed at the same planar positions are fixed so that the first substrate 61a and the second substrate 61b are laminated and arranged with a gap. It is arranged that the second connection terminals 66a have a height higher than that of the second coil conductors 63a. A greater number of the inductors may be laminated to increase the number of the output systems.

A coil of the first inductor 60a is composed of the first coil conductors 62a formed on the first principal surface, the first coil conductors 62b formed on the second principal surface, and the first connecting conductors 64a connecting the first coil inductors 62a and 62b.

A coil of the second inductor 60b is composed of the second coil conductors 63a formed on the first principal surface, the second coil conductors 63b formed on the second principal surface, and the second connecting conductors 64b connecting the second coil inductors 63a and 63b.

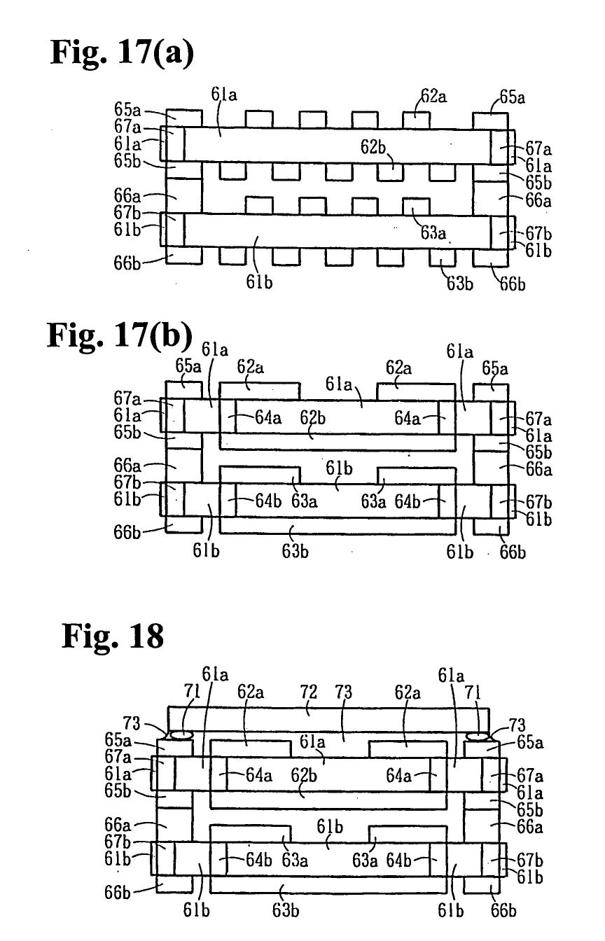

FIGS. 17(a) and 17(b) are cross sectional views showing the first inductor and the second inductor shown in FIGS. 16(a) and 16(b). FIG. 17(a) is a cross sectional view taken along line 17(a)-17(a) in FIGS. 16(a) and 16(b), and FIG. 17(b) is a cross sectional view taken along line 17(b)-17(b) in FIGS. 16(a) and 16(b). FIG. 17(a) and FIG. 17(b) show the first connection terminals 65a and 65b, the second connection terminals 66a and 66b, and the coil patterns of the inductors.

As shown in FIGS. 16(a) and 16(b), the first coil conductors 62b formed on the second principal surface have a straight line shape and are electrically connected to the first coil conductors 62a formed on the first principal surface through the connecting conductors 64a. The first coil conductors 62a are formed on the first principal surface slightly oblique with respect to the first coil conductors 62b, so that the adjacent first conductors 62b are connected to each other. The coil composed of the first coil conductors 62a and 62b and the connecting conductors 64a has a solenoid shape.

The second conductors 63a and 63b formed on the second substrate 61b are similar to the first coil conductors 62a and 62b formed on the first substrate 61a. The second coil conductors 63a formed on the first principal surface are electrically connected to the second coil conductors 63b formed on the second principal surface through the connecting conductors 64b.

Each of the first inductor 60a and the second inductor 60b has the magnetic substrate as a magnetic core. The first substrate 61a and the second substrate 61b are arranged with a gap therebetween and do not contact, so that the gap magnetically isolates the first and second inductors 60a and 60b from each other. When the first and second inductors 60a and 60b are magnetically isolated, an induced mutual voltage is not generated upon a current flow in the inductor 60a and the inductor 60b in an operation as a power supply (low mutual inductance with little effect on the operation of the power supply).

The inductor 60a and the inductor 60b are formed in a two-layer laminated structure by bonding the first connection terminals 65b on the first substrate 61a to the second connection terminals 66a on the second substrate 61b with a method such as soldering, ultrasonic bonding, conductive paste, thermo-compression, and anisotropic conductive material. The first and the second connection terminals have surfaces formed of a material suitable for the bonding, for example, copper tin, and solder in the case of soldering, and gold in the case of ultrasonic bonding and thermo-compression.

No electromagnetic characteristic is affected even if the space between the first substrate 61a and the second substrate 61b is not filled. However, it is preferable to fill the space with a resin and join the two substrates considering mechanical strength and long-term reliability.

FIG. 18 is a cross sectional view showing an essential part of a micro power converter with multiple outputs according to a fourth embodiment of the present invention. The micro power converter with multiple outputs includes the inductors 60a and 60b shown in FIGS. 16(a) and 16(b).

A semiconductor substrate 72 (integrated circuit for power supply) is arranged above the first principal surface of the first substrate 61a, so that two main components of a power converter, i.e. an inductor and power supply IC, are combined in a small scale. The power supply IC is designed to have two output systems and is combined with the two inductors, i.e. the first inductor 60a and the second inductor 60b, so that the power converter has two output systems. As shown in FIG. 18, stud bumps 71 are formed on the semiconductor substrate 72 and bonded to the first connection terminals 65a formed on the first substrate 61a with ultrasonic, thereby joining the semiconductor substrate 72 with the power supply IC to the inductors 60a and 60b. Under-filler 73 may be provided for sealing if necessary.

Referring to FIGS. 16(a) and 16(b), the first connector terminals 65a at A and B are connected to the stud bumps 71, so that an electric current flows from the power supply IC on the semiconductor substrate 72 to the first inductor 60a. The first connector terminals 65a at E connected to the second connector terminal 66a at C and the first connector terminal 65a at F connected to the second connector terminal 66a at D are connected to the stud bumps 71, so that an electric current flows from the power supply IC on the semiconductor substrate 72 to the second inductor 60b. Other stud bumps 71 formed on the semiconductor substrate 72 are connected to other first connector terminals 65a of the first inductor 60a.

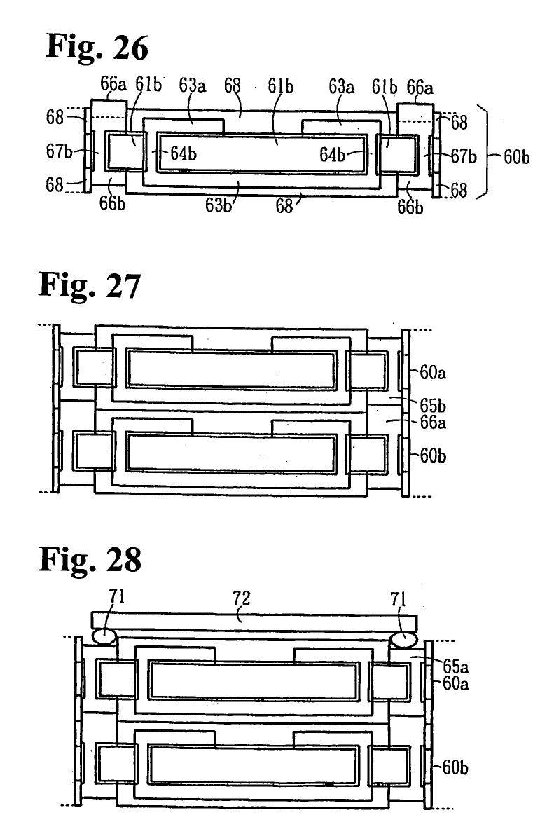

A capacitor is omitted in FIG. 18, and may be as an external capacitor. A capacitor component such as a laminated ceramic array may be disposed below a back surface of the second inductor, thereby further reducing a size of the power converter. Such a capacitor is electrically connected through the second connection terminals 66b formed on the back surface of the second substrate 61b. Each of the coil conductors 62a, 62b, 63a and 63b is covered with a protective film 68 (not shown in FIGS. 16(a) and 16(b), see FIG. 26) formed of an insulation resin for protection.

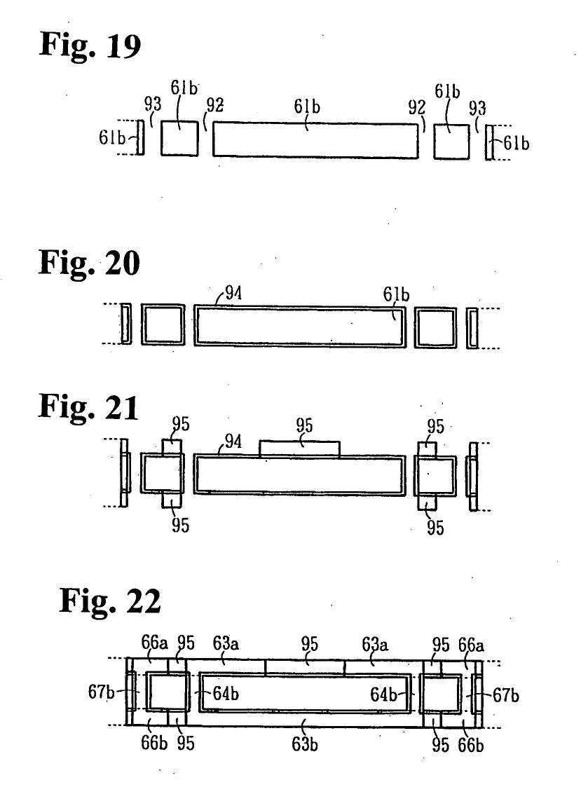

FIGS. 19 through 29 are cross sectional views showing a method of manufacturing the micro power converter with multiple outputs shown in FIG. 18. The cross sectional views are similar to the cross sectional view taken along line 17(b)-17(b) in FIGS. 16(a) and 16(b). The first inductor 60a and the second inductor 60b are formed in an almost same method. The two inductors are manufactured separately and joined together. FIGS. 19 through 29 show a method of manufacturing the second inductor 60b.

A ferrite substrate formed of Ni—Zn and having a thickness of 525 μm is used as the second substrate 61b. A thickness of the magnetic insulation substrate is determined according to required inductance, a value of coil current, and properties of the magnetic substrate, and is not limited to the embodiment. When the magnetic insulation substrate has an extremely small thickness, magnetic saturation tends to occur, and when the substrate has a large thickness, the power converter itself has a large thickness. Accordingly, it is necessary to select a thickness according to a purpose of the power converter. The ferrite is used for the magnetic insulation substrate. Alternatively, other materials with appropriate insulation and magnetic properties may be used. The ferrite substrate is selected as it is easy to form in a substrate shape.

As shown in FIG. 19, through holes 92 and 93 are formed for connecting the second coil conductors 63′a and 63b to the second connection terminals 66a and 66b through the connecting conductors 64b and 67b. The through holes 92 and 93 can be formed with a method such as laser beam machining, sand blasting, electric discharge machining, ultrasonic machining, and drilling according to machining cost and machining dimension. In the embodiment, the sand blasting method is employed, since a minimum width of machining dimension is 130 μm and a large number of places are machined. The substrate 61b has a size shown by solid line in the FIG. 19 for installing a single inductor. An actual substrate has a larger size shown by the hidden line for manufacturing a plurality of inductors, and the substrate is cut into individual inductors in the last step.

Then, the connecting conductors 64b and 67b at the through holes, the second coil conductors 63a and connection terminals 66a on the first principal surface, and the second coil conductors 63b and connection terminals 66b on the second principal surface are formed.

Referring to FIG. 20, in order to provide electrical conductivity, Ti/Cu is deposited on the whole surface of the substrate with sputtering to form plating seed layers 94. The plating seed layers 94 can alternatively formed with electroless plating. Instead of the sputtering method, vacuum deposition or CVD (chemical vapor deposition) may be used. It is preferred that the deposited layer has a sufficient adhesion to the substrate. The conductive material may be any appropriate material with electrical conductivity. In the embodiment, titanium is used as an adhesive layer to obtain good adhesion, and other materials such as Cr, W, Nb, and Ta may be used. The copper layer is a seed layer to be plated in the nest step of electroplating, and nickel or gold may be used instead of copper. In the embodiment, Ti/Cu is used considering ease of machining in the later steps.

As shown in FIG. 21, a photo-resist 95 is applied to form a resist pattern with photolithography for forming the second coil conductors 63a and second connection terminals 66a on the first principal surface and the second coil conductors 63b and second connection terminals 66b on the second principal surface. In the embodiment, a negative type pattern is formed with a film type photo-resist, and the photo-resist 95 has a thickness of 40 μm.

As shown in FIG. 22, copper is plated at openings of the resist pattern with electroplating. At this time, copper is plated at the through holes 92 and 93, and the connecting conductors 64b and 67b are formed. The second coil conductors 63a on the first principal surface are connected to the second coil conductors 63b on the second principal surface to form the solenoid coil. A pattern of the second connection terminals 66a and 66b are also formed at this time. The copper layer has a thickness of 35 μm.

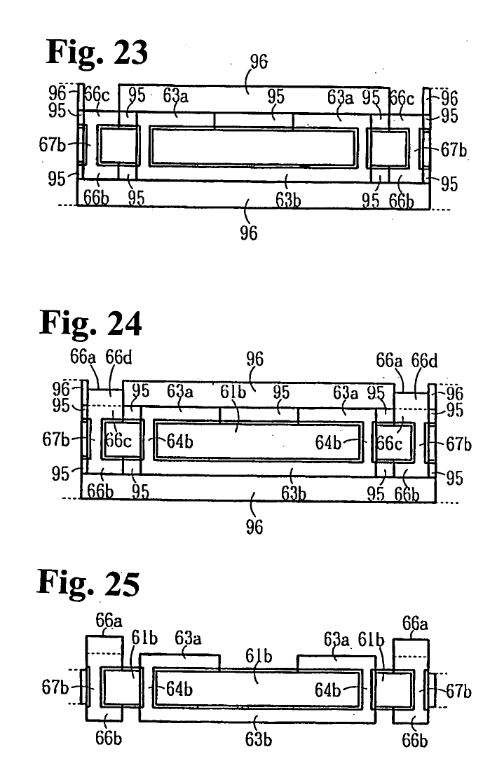

Then, as shown in FIG. 23, the photo-resist 96 is applied and a resist pattern is formed with photolithography. As shown in FIG. 24, a metallic film 66d is additionally formed on the metallic film 66c formed previously with electroplating to raise the second connection terminal 66a. Accordingly, only the second connection terminals 66a have a larger thickness to avoid contact between the first coil conductors 62b and the second coil conductors 63a when the first substrate 61a and the second substrate 61b are combined. Since the second principal surface (back surface) does not need to have a larger thickness, the surface is covered with a plain resist film 96 without a pattern. The steps shown in FIGS. 23 and 24 are not necessary for manufacturing the first inductor 60a, but not limited thereto. An increased amount of the thickness of the metallic film 66d is 5 μm. Accordingly, the second connection terminals 66a have a height larger than that of the coil conductors 63a, thereby magnetically isolating the first inductor 60a from the second inductor 60b.

As shown in FIG. 25, after the electroplating, unnecessary resist and conductive layers are removed to form the second coil conductors 63a and 63b and second connection terminals 66a and 66b. The second coil conductors 63a and 63b are covered with insulator film 68 as shown in FIG. 26. In the embodiment, the film type insulator material is used. The protective film is not indispensable, however, it is preferred that the film is formed considering long-term reliability. The protective film is not limited to the film type, and a liquid insulator material may be applied by screen print in a pattern and thermally cured.

Incidentally, if necessary, nickel or gold may be plated on surfaces of the second coil conductors 63a and 63b and the second connection terminals 66a and 66b to form a surface treatment layer. In the embodiment, in the step shown in FIG. 22, nickel and gold are plated after copper is plated. In FIG. 24, gold is plated to increase the thickness of the second connecting terminals 66a. The surface treatment layer may be formed with electroless plating after the step shown in FIG. 25 or shown in FIG. 26. The protective metallic conductive layer is provided for obtaining stable connection when the IC is connected in a later step.

The first inductor 60a is formed with the process similar to that of the second inductor 60b described above. As shown in FIG. 27, the first inductor 60a is fixed to the second inductor 60b with the first connection terminals 65b and the second connection terminals 66a. Since the second connection terminals 66a have a larger thickness, a gap is generated between the first substrate 61a and the second substrate 61b to magnetically isolate the two substrates. The first coil conductors 62b do not contact the second coil conductors 63a.

The two substrates are bonded with thermo-compression bonding, and may be bonded with soldering, conductive paste bonding, ultrasonic bonding, or a method using an anisotropic conductive material considering a temperature and other conditions in the later steps. If necessary, the space between the two substrates may be filled with a resin material. The resin can be applied beforehand or injected afterward. In the case that the two substrates are bonded together, it is preferable to apply beforehand.

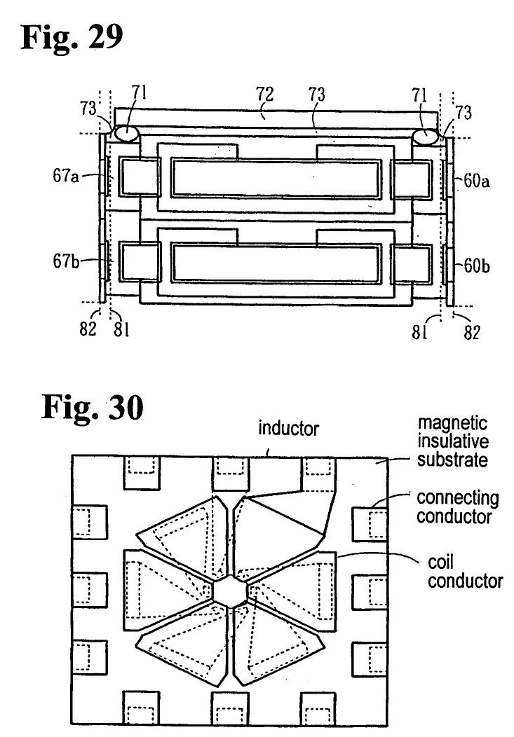

As shown in FIG. 28, the semiconductor substrate 72 with the power supply IC mounted thereon is connected to the first connection terminals 65a formed on the first substrate 61a. In the embodiment, stud bumps 71 are formed on the semiconductor substrate 72 with the power supply IC, and the stud bumps 71 are bonded to the first connection terminals 65a with ultrasonic bonding. Then, as shown in FIG. 29, after the semiconductor substrate 72 is fastened to the first inductor 60a with the under-filling 73, the assembled body is cut along a cut line 81 so that the micro converter device is completed. In the embodiment, the semiconductor substrate 72 is fixed with the stud bumps 71 and ultrasonic bonding. A method of fixing is not limited thereto, and soldering or a conductive adhesive may be used. It is preferred that a connection point has a resistance as small as possible. The assembled body may be cut along a cut line 82 so that the connection terminals 65a, 65b, 66a and 66b and the connecting conductors 67a and 67b are not exposed at the side faces.

In the embodiment, the semiconductor substrate 72 is fastened to the first inductor 60a with the under-filling 73. A material such as an epoxy resin may be used for the under-filling. The under-filling fastens the components for obtaining long-term reliability, and has no effect on initial performance of the power converter. It is preferred to provide the under-filling for the long-term reliability.

With the process described above, it is possible to reduce a size of the power converter with the parts (power supply IC and inductors) mounted thereon other than the capacitor. The power converter has two output systems, and a mounting area is smaller than a case in which two micro power converters with a single output system are arranged.

In particular, a micro power converter with a single output system has a size of 3.5 mm wide and 3.5 mm long. Accordingly, it is necessary to provide a mounting area of at least 3.5 mm×7.0 mm to obtain two output systems. The inductors have a thickness of about 0.6 mm and the semiconductor substrate 72 with the power supply IC has a thickness of about 0.3 mm, so that an overall thickness is about 0.9 mm. An actual mounting area needs to have a length of at least 7.2 mm (thickness of 0.9 mm).

On the other hand, in the embodiment, a mounting area is 3.5 mm wide and 3.5 mm long. A thickness is about 1.5 mm since a thickness of one inductor is added. Thus, the mounting area is reduced in half, and a total volume of the power converter is reduced to about 80% of the conventional one, thereby making mounting cost half.

A ceramic capacitor and the like may be bonded to a surface opposite to the surface that the IC is mounted, thereby further reducing a size. In the fourth embodiment described above, the first and second inductors 60a and 60b are formed on the first and second substrates without changing a size and thickness thereof. In an actual case, it is necessary to make a thickness as small as possible due to a restriction in the thickness direction.

According to a fifth embodiment, the ferrite substrate with a thickness of 0.3 mm is used. Each of the first and second inductors 60a and 60b is enlarged to 4 mm wide and 4 mm long, and the number of turns of the coil is increased from 11 to 14 corresponding to the increase in the size. In this case, since the size and the number of the turns are increased, it is possible to decrease a thickness to about 0.4 mm while maintaining inductance of 2.0/H, i.e. same as that of the fourth embodiment before the enlargement. A micro power converter manufactured with the inductor has a planar size of 4 mm×4 mm and a thickness of 1.1 mm including the semiconductor substrate 72, i.e. 57% reduction in the mounting area and 80% reduction in the volume. It is possible to optimize the planar size and thickness within permissible limits.

The coil conductors of the inductor have a solenoid shape, and the coil conductors may have a toroidal shape as shown in FIG. 30. A toroidal coil has a closed magnetic path structure in which a magnetic flux generated by the coil passes within a magnetic substrate. The inductors having the toroidal coils can be laminated to form a micro power converter with multiple outputs.

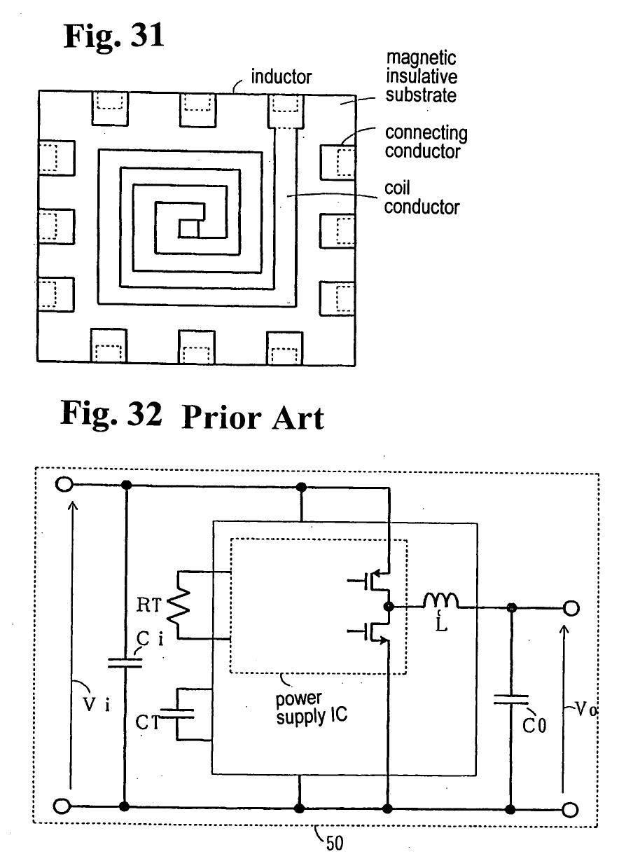

A spiral coil shown in FIG. 31 has an open magnetic path structure in which the magnetic flux leaks toward outside. Consequently, it is necessary to magnetically isolate the inductors. In this case, the inductors may be laminated with a relatively large gap to form a micro power converter with multiple outputs.

As described above, according to the embodiments of the present invention, a plurality of the inductors is mounted on the magnetic insulation substrate with the magnetic isolation layer disposed between the inductors. Alternatively, a plurality of the magnetic substrates with the inductors is laminated with a gap therebetween. With the configurations, instead of a plurality of micro power converters required for output systems, it is possible to integrate the micro power converter with multiple outputs, thereby reducing a mounting area and cost.

While the invention has been explained with reference to the specific embodiments of the invention, the explanation is illustrative and the invention is limited only by the appended claims.

What is claimed is:

1. A micro power converter with multiple outputs, comprising:
a semiconductor substrate having a semiconductor integrated circuit,
a plurality of thin film magnetic induction components electrically connected to the semiconductor integrated circuit and having a plurality of the magnetic insulation substrates, said plurality of thin film magnetic induction components being spaced apart from each other with a gap therebetween, and
a capacitor electrically connected to the semiconductor integrated circuit.

2. A micro power converter according to claim 1, further comprising a magnetic isolation layer disposed in the gap between the magnetic insulation substrates for magnetically isolating the thin film magnetic induction components.

3. A micro power converter according to claim 1, wherein each of said thin film magnetic induction components includes one of said magnetic insulation substrates, a coil conductor formed on the one magnetic insulation substrate, and a plurality of connection terminals formed at a peripheral portion of said one magnetic insulation substrate, said plurality of the thin film magnetic induction components being arranged with the gap and attached at the plurality of the connection terminals.

4. A micro power converter according to claim 1, wherein said plurality of the magnetic insulation substrates is formed of a ferrite substrate.

5. A micro power converter according to claim 2, wherein said magnetic isolation layer is formed of a non-magnetic material.

6. A micro power converter according to claim 5, wherein said non-magnetic material is a resin material.

7. A micro power converter according to claim 5, wherein said non-magnetic material is a ceramic material.

8. A micro power converter according to claim 3, wherein said plurality of the connection terminals is formed on each of the plurality of the magnetic insulation substrates at same planar positions, said plurality of the connection terminals connected to two ends of each coil inductor and located on one magnetic insulation substrate being located at planar positions different from those of another magnetic insulation substrate.

9. A micro power converter according to claim 8, wherein one of said plurality of the connection terminals formed on one magnetic insulation substrate faces another magnetic insulation substrate, and has a height greater than that of the coil conductor formed on the one magnetic insulation substrate.

10. A micro power converter according to claim 3, wherein said plurality of the connection terminals includes a first terminal formed on a front surface of one magnetic insulation substrate and a second terminal formed on a rear surface of the one magnetic insulation substrate, said first terminal being electrically connected to the second terminal through a hole formed in the one magnetic insulation substrate.

11. A micro power converter according to claim 10, wherein said semiconductor substrate is electrically connected to the first terminal.

12. A micro power converter according to claim 10, wherein said capacitor is electrically connected to the first terminal.
